(19) United States
(12) Patent Application Publication
(10) Pub. No.: US 2023/0403721 A1
(43) Pub. Date: Dec. 14, 2023

(54) METHOD FOR DATA PROCESSING AND USER EQUIPMENT

(71) Applicant: SPREADTRUM COMMUNICATIONS (SHANGHAI) CO., LTD., Shanghai (CN)

(72) Inventors: Huayu ZHOU, Shanghai (CN); Sicong ZHAO, Shanghai (CN); Zhenzhu LEI, Shanghai (CN); Zhengang PAN, Shanghai (CN)

(21) Appl. No.: 18/250,249

(22) PCT Filed: Oct. 22, 2021
(86) PCT No.: PCT/CN2021/125880

§ 371 Date: Apr. 24, 2023

(30) Foreign Application Priority Data
Oct. 23, 2020 (CN) 202011149526.8

(51) Int. Cl. H04W 72/232; H04W 76/28

(52) U.S. Cl. CPC H04W 72/232; H04W 76/28

(57) ABSTRACT

A method for data processing is provided. The method includes the following. A user equipment (UE) receives a physical downlink control channel (PDCCH), obtains one or more bits in the PDCCH, and determines whether parameter change occurs to one or more search space sets based on the one or more bits.

### CROSS-REFERENCE TO RELATED APPLICATION(S)

This application is a National Stage of International Application No. PCT/CN2021/125880, filed Oct. 22, 2021, which claims priority to Chinese Patent Application No. 202011149526.8, filed on Oct. 23, 2020, both of which are incorporated herein by reference in their entireties.

### TECHNICAL FIELD

This disclosure relates to the field of communication technology, and particularly to methods for data processing and a user equipment.

### BACKGROUND

User equipment (UE) needs to monitor a physical downlink control channel (PDCCH) in a configured monitoring occasion (MO), to obtain uplink (UL) and downlink (DL) resource scheduling information for receiving data. There may be multiple PDCCH candidates per MO. Therefore, the UE may need to blindly detect PDCCH candidates multiple times.

Generally, UL and DL resource scheduling includes UL grant and DL assignment. Since arrival of data packets is random, and a scheduler needs to coordinate resources for multiple UEs, a network device may not send PDCCHs to a certain UE in some MOs. The UE may perform PDCCH blind detection in these MOs, but may detect no PDCCH. Therefore, how to effectively indicate PDCCH monitoring is an urgent problem to be solved.

### SUMMARY

Methods for data processing and a user equipment (UE) are provided in implementations of the disclosure.

In a first aspect, a method for data processing is provided in implementations of the disclosure. The method includes the following. Receive a physical downlink control channel (PDCCH) and obtain one or more bits in the PDCCH. Determine whether parameter change occurs to one or more search space sets based on the one or more bits.

In a second aspect, a method for data processing is provided in implementations of the disclosure. The method includes the following. Transmit a PDCCH, where one or more bits in the PDCCH are used to determine whether parameter change occurs to one or more search space sets.

In a third aspect, a UE is provided in implementations of the disclosure. The UE includes a transceiver, a processor coupled with the transceiver, and a memory storing a computer program. The computer program is executed by the processor to cause the UE to receive a PDCCH, obtain one or more bits in the PDCCH, and determine whether parameter change occurs to one or more search space sets based on the one or more bits.

### BRIEF DESCRIPTION OF THE DRAWINGS

In order to further illustrate technical solutions in implementations of the disclosure, the accompanying drawings required for illustration of the implementations will be briefly introduced. Obviously, the accompanying drawings described below only illustrate some implementations of the disclosure, and a person of ordinary skill in the art can obtain other accompanying drawings without creative efforts based on these accompanying drawings.

FIG. 1 is a schematic diagram of a communication system provided in implementations of the disclosure.

FIG. 2 is a schematic flow chart of a method for data processing provided in implementations of the disclosure.

FIG. 3 is a schematic structural diagram of an apparatus 300 for data processing provided in implementations of the disclosure.

FIG. 4 is a schematic structural diagram of an apparatus 400 for data processing provided in implementations of the disclosure.

FIG. 5 is a schematic structural diagram of a computer device 500 for data processing provided in implementations of the disclosure.

### DETAILED DESCRIPTION

The terms used in implementations of the disclosure are only for the purpose of illustrating specific implementations of the disclosure rather than limiting the disclosure. The terms “first”, “second”, “third”, “fourth”, and the like used in the specification, the claims, and the accompany drawings of the disclosure are used to distinguish different objects rather than describe a particular order. In addition, the terms “include”, “comprise”, and “have” as well as variations thereof are intended to cover non-exclusive inclusion.

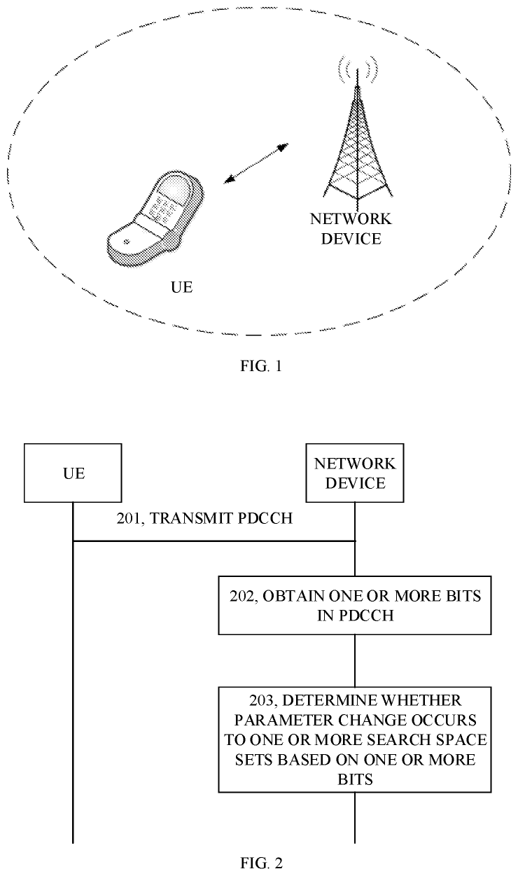

Referring to FIG. 1, FIG. 1 is a schematic architecture diagram illustrating a communication system provided in implementations of the disclosure. The communication system includes a network device and a user equipment (UE). As illustrated in FIG. 1, the network device can communicate with the UE. The communication system may be a global system for mobile communication (GSM), a code division multiple access (CDMA) system, a wideband code division multiple access (WCDMA) system, a worldwide interoperability for microwave access (WiMAX) system, a long term evolution (LTE) system, a 5th generation (5G) communication system (e.g., new radio (NR)), a communication system integrating multiple communication technologies (e.g., a communication system integrating LTE technology and NR technology), or a subsequent evolved communication system. The forms and number of the network device and the UE in FIG. 1 are only for examples and do not constitute any limitation on the implementations of the disclosure.

The UE in the implementations of the disclosure may be a device with wireless communication functions and deployed on land, including indoor or outdoor, handheld, wearable, or vehicle-mounted; on water (e.g., a ship); and also in the air (e.g., aircraft, balloons, and satellites). The UE may be a mobile phone, a pad, a computer with wireless transceiving functions, a virtual reality (VR) device, an augmented reality (AR) device, a wireless terminal in industrial control, a wireless terminal in self driving, a wireless terminal in remote medical, a wireless terminal in smart grid, a wireless terminal in smart home, or the like. The UE may also be a device with wireless communication functions, such as a handheld device, an in-vehicle device, a wearable device, a computer device, or other processing devices coupled with a wireless modem. The UE may have different names in different networks, such as an access terminal, a subscriber unit, a subscriber station, a mobile station, a mobile platform, a remote station, a remote terminal, a mobile device, a user terminal, a terminal, a wireless communication device, a user agent or a user apparatus, a cellular radio telephone, a cordless telephone, a session initiation protocol (SIP) telephone, a wireless local loop (WLL) station, a personal digital assistant (PDA), or a terminal device in the 5G network or a future evolved network.

The network device in the implementations of the disclosure is a device deployed in a radio access network (RAN) to provide wireless communication functions. For example, the network device may be an RAN device at an access network side in the cellular network. The RAN device is configured to connect the UE to the radio network, including but not limited to an evolved node b (eNB), a radio network controller (RNC), a node B (NB), a base station controller (BSC), a base transceiver station (BTS), a home base station (e.g., a home evolved node B, home node B, or HNB), a base band unit (BBU), or a mobility management entity (MME). For example, the network device may also be a node device in a wireless local area network (WLAN), e.g., an access controller (AC), a gateway, or a WiFi access point (AP). For example, the network device may also be a transmission point (TP) or a transmission reception point (TRP) in the NR system.

For ease of understanding, the following first introduces relevant terms involved in the specification.

1) A search space set includes a physical downlink control channel (PDCCH) monitoring occasion (MO), a search space type, and the like. A PDCCH MO includes a slot periodicity, a slot offset, a slot-in start symbol, and the like, for monitoring. A search space set is generally associated to a control resource set (CORESET). A CORESET contains frequency domain resources and duration (the number (quantity) of symbols) of a PDCCH, etc. A PDCCH consists of one or more control channel elements (CCEs). If a PDCCH consists of n CCEs, an aggregation level of the PDCCH is n. A CCE consists of 6 resource element groups (REGs). An REG is equivalent to a resource block (RB) in an orthogonal frequency division multiplexing (OFDM) symbol. REGs in a CORESET are numbered from the minimum to the maximum in a time-first manner, and number 0 is the minimum number and corresponds to an RB in the first OFDM symbol in the CORESET. A CORESET is associated with a CCE-to-REG mapping. A CCE-to-REG mapping in a CORESET can be interleaved or non-interleaved, and is described by REG bundles.

The i-th REG bundle is defined as REGs, numbered as {iL, iL+1, . . . , iL+L−1}, where L represents the number of REG bundles, i=0, 1, . . . , N_{REG}^{CORESET}/L−1, and N_{REG}^{CORESET}=N_{RB}^{CORESET}N_{symb}^{CORESET}, where N_{REG}^{CORESET} represents the number of REGs in a CORESET.

The j-th CCE consists of REG bundles numbered as {f(6j/L), f(6j/L+1), f(6j/L+6/L−1)}, where f(x) represents an interleaver. For a non-interleaved CCE-to-REG mapping, L=6, and f(x)=x. For an interleaved CCE-to-REG mapping, L=6, f(x)=x, L∈{2,6} corresponds to N_{symb}^{CORESET}=1, and L∈{N_{symb}^{CORESET},6} corresponds to N_{symb}^{CORESET}∈{2,3}. The interleaver is defined as:

f(x)=(rC+c+n_{shift})mod(N_{REG}^{CORESET}/L)

x=cR+r

r=0,1, . . . ,R−1

c=0,1, . . . ,C−1

C=N_{REG}^{CORESET}/(LR)

where R∈{2,3,6}.

Referring to FIG. 2, FIG. 2 is a schematic flow chart of a method for data processing provided in implementations of the disclosure. The method includes the following.

At 201, a network device transmits a PDCCH, and a UE receives the PDCCH.

At 202, the UE obtains one or more bits in the PDCCH, where the one or more bits are used to determine whether parameter change occurs to one or more search space sets.

At 203, the UE determines whether parameter change occurs to the one or more search space sets based on the one or more bits.

It can be seen that in the implementations of the disclosure, the UE receives the PDCCH transmitted by the network device, obtains one or more bits in the PDCCH, and determines whether parameter change occurs to the one or more search space sets based on the one or more bits, such that the UE can perform PDCCH monitoring based on changed parameters in the case where parameter change occurs, so as to achieve adaptive monitoring and ultimately achieve power saving.

Specifically, the UE detects a PDCCH, and one or more bits in the PDCCH only indicate whether parameter change occurs to one or more search space sets, and parameters of other search space sets are not affected.

A PDCCH MO is determined by a parameter of a search space set. In addition, a search space set may correspond to a service type. For example, the network device can set a slot periodicity of a search space set for a voice over IP (VoIP) service to 1 (since VoIP services are relatively dense in time), and the network device can also set a slot periodicity of a search space set for a file transfer protocol (FTP) service to 2 (since FTP services are relatively sparse in time). Therefore, parameter change of a search space set for a PDCCH is equivalent to PDCCH MO change under a service type, so that self-adaptation for different PDCCH MOs under different service types can be realized.

In an implementation manner, parameter non-change of a search space set indicates that a periodicity of the search space set is a periodicity of a configured search space set.

The configured search space set is configured by the network device through signaling. The signaling may be high-layer semi-static signaling or other signaling.

In an implementation manner, parameter change of a search space set indicates that a periodicity of the search space set is N times the periodicity of the configured search space set, where N is an integer greater than 1.

N is configured by the network device through signaling. The signaling may be high-layer semi-static signaling or other signaling. The value of N may be, for example, 2, 3, 4 or other values.

It can be seen that the increase of a periodicity can relax PDCCH monitoring of the UE to realize power saving. In addition, the combination of high-layer semi-static signaling and dynamic signaling is conducive to reducing signaling overhead.

In an implementation manner, parameter non-change of a search space set indicates that a periodicity of the search space set is a first periodicity of the configured search space set.

In an implementation manner, parameter change of a search space set indicates that a periodicity of the search space set is a second periodicity of the configured search space set.

The first periodicity is different from the second periodicity.

In an implementation manner, parameter non-change of a search space set indicates that any parameter of the search space set is unchanged.

In an implementation manner, parameter change of a search space set indicates that a PDCCH MO of the search space set is skipped for a duration.

Optionally, the duration includes Y monitoring periodicities, Y time slots, or Y milliseconds, where Y is a positive integer.

Y is configured by the network device through signaling. The signaling may be high-layer semi-static signaling or other signaling.

It can be seen that the UE may not perform PDCCH monitoring for a period of time to achieve power saving. In addition, the combination of high-layer semi-static signaling and dynamic signaling is conducive to reducing signaling overhead.

In one implementation, the method may further include the following. On condition that the UE determines that parameter change occurs to a search space set, the UE starts a timer; and in response to expiration of the timer, the UE determines that parameter non-change occurs to the search space set.

It can be seen that the UE can automatically return to an “original” PDCCH MO via the timer, so as to avoid the problem that the UE fails to return in time to the “original” PDCCH MO in the case where the UE misses a PDCCH, thereby avoiding loss of scheduling information sent by the network device.

In an implementation, the method may further include determining that parameter non-change occurs to a search space set in a next discontinuous reception (DRX) cycle.

It can be seen that the UE can automatically return to the “original” PDCCH MO in the next DRX cycle, so as to avoid the problem that the UE fails to return in time to the “original” PDCCH MO in the case where the UE misses a PDCCH, thereby avoiding loss of scheduling information sent by the network device.

In an implementation manner, one bit in the PDCCH is used to determine whether parameter change occurs to one search space set. The UE determines whether parameter change occurs to the one or more search space sets based on the one or more bits as follows. The UE determines whether parameter change occurs to one search space set based on the one bit.

Optionally, the one search space set is a search space set to which the PDCCH belongs.

Optionally, on condition that the one bit indicates parameter non-change, parameter non-change is determined to occur to the one search space set. If the one bit indicates parameter change, parameter change is determined to occur to the one search space set.

On condition that the value of the one bit is 0, the one bit indicates parameter non-change, and on condition that the value of the one bit is 1, the one bit indicates parameter change. Alternatively, on condition that the value of the one bit is 1, the one bit indicates parameter non-change, and on condition that the value of the one bit is 0, the one bit indicates parameter change.

It can be seen that the network device can use one bit in the PDCCH to indicate whether parameter change occurs to one search space set, which can save bits.

In an implementation manner, two bits in the PDCCH are used to determine whether parameter change occurs to two search space sets, and the UE determines whether parameter change occurs to the one or more search space sets based on the one or more bits as follows. The UE determines whether parameter change occurs to two search space sets based on the two bits.

Optionally, the two search space sets include the search space set to which the PDCCH belongs and a search space set associated with the PDCCH.

Optionally, on condition that one bit in the two bits indicates parameter non-change, parameter non-change is determined to occur to a search space set corresponding to the one bit. On condition that the one bit in the two bits indicates parameter change, parameter change is determined to occur to the search space set corresponding to the one bit.

The two bits and the two search space sets are in one-to-one correspondence, and the one-to-one correspondence between the two bits and the two search space sets is configured by the network device through signaling. The signaling may be high-layer semi-static signaling or other signaling.

On condition that the value of the one bit is 0, the one bit indicates parameter non-change, and on condition that the value of the one bit is 1, the one bit indicates parameter change. Alternatively, on condition that the value of the one bit is 1, the one bit indicates parameter non-change, and on condition that the value of the one bit is 0, the one bit indicates parameter change.

It can be seen that the network device can use two bits in the PDCCH to indicate whether parameter change occurs to two search space sets. In the case where the UE misses a PDCCH, the UE can obtain parameters of a search space set to which the missed PDCCH belongs by successfully detecting another PDCCH, which has a double protection function and is more reliable.

In an implementation manner, at least two bits in the PDCCH are used to determine whether parameter change occurs to multiple search space sets, and the UE determines whether parameter change occurs to the one or more search space sets based on the one or more bits as follows. The UE determines whether parameter change occurs to multiple search space sets based on the at least two bits.

Optionally, the multiple search space sets include the search space set to which the PDCCH belongs and at least two search space sets associated with the PDCCH.

Optionally, the method further includes the following. On condition that the at least two bits indicate target information, determine whether parameter change occurs to each search space set in the multiple search space sets based on the target information, where the target information contains information indicative of whether parameter change occurs to each search space set in the multiple search space sets.

The target information is configured by the network device through signaling. The signaling may be high-layer semi-static signaling or other signaling. The target information is a row in a table, and the table records information indicative of whether parameter change occurs to each search space set.

It can be seen that the network device can use at least two bits in the PDCCH to indicate whether parameter change occurs to at least three search space sets. In the case where the UE misses a PDCCH, the UE can obtain parameters of a search space set to which the missed PDCCH belongs by successfully detecting another PDCCH, which has a double protection function and is more reliable.

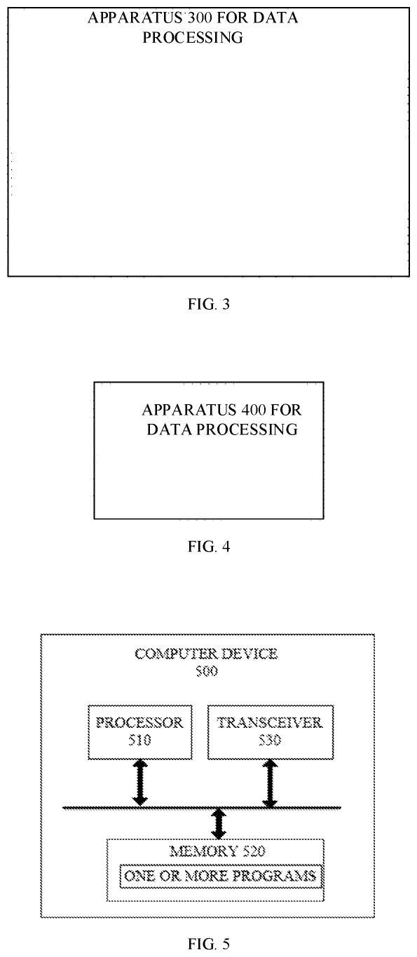

FIG. 3 illustrates an apparatus 300 for data processing provided in implementations of the disclosure. The apparatus 300 may be a terminal device or a chip in the terminal device. The apparatus 300 includes a receiving unit 310, an obtaining unit 320, and a determining unit 330. The receiving unit 310 is configured to receive a PDCCH. The obtaining unit 320 is configured to obtain one or more bits in the PDCCH. The determining unit 330 is configured to determine whether parameter change occurs to one or more search space sets based on the one or more bits.

In an implementation manner, parameter non-change of a search space set indicates that a periodicity of the search space set is a periodicity of a configured search space set.

In an implementation manner, parameter change of a search space set indicates that a periodicity of the search space set is N times a periodicity of the configured search space set, where N is an integer large than 1.

In an implementation manner, parameter non-change of a search space set indicates that a periodicity of the search space set is a first periodicity of the configured search space set.

In an implementation manner, parameter change of a search space set indicates that a periodicity of the search space set is a second periodicity of the configured search space set.

In an implementation manner, parameter non-change of a search space set indicates that any parameter of the search space set is unchanged.

In an implementation manner, parameter change of a search space set indicates that a PDCCH monitoring occasion (MO) of the search space set is skipped for a duration.

In an implementation manner, the duration includes Y monitoring periodicities, Y slots, or Y milliseconds, where Y is a positive integer.

In an implementation manner, the apparatus 300 further includes a starting unit 340. The starting unit 340 is configured to start a timer upon determining that parameter change occurs to a search space set. The determining unit 330 is further configured to determine that parameter non-change occurs to the search space set in response to expiration of the timer.

In an implementation manner, the determining unit 330 is further configured to determine that parameter non-change occurs to a search space set in a next DRX cycle.

In an implementation manner, in terms of determining whether parameter change occurs to the one or more search space sets based on the one or more bits, the determining unit 330 is configured to determine whether parameter change occurs to one search space set based on one bit.

Optionally, the one search space set is a search space set to which the PDCCH belongs.

Optionally, parameter non-change is determined to occur to the one search space set on condition that the one bit indicates parameter non-change, and parameter change is determined to occur to the one search space set on condition that the one bit indicates parameter change.

In an implementation manner, in terms of determining whether parameter change occurs to the one or more search space sets based on the one or more bits, the determining unit 330 is configured to determine whether parameter change occurs to two search space sets based on two bits.

Optionally, the two search space sets include the search space set to which the PDCCH belongs and a search space set associated with the PDCCH.

Optionally, parameter non-change is determined to occur to a search space set corresponding to one bit in the two bits on condition that the one bit indicates parameter non-change, and parameter change is determined to occur to the search space set corresponding to the one bit in the two bits on condition that the one bit indicates parameter change.

In an implementation manner, in terms of determining whether parameter change occurs to the one or more search space sets based on the one or more bits, the determining unit 330 is configured to determine whether parameter change occurs to multiple search space sets based on at least two bits.

Optionally, the multiple search space sets include a search space set to which the PDCCH belongs and at least two search space sets associated with the PDCCH.

Optionally, the determining unit 330 is further configured to determine whether parameter change occurs to each search space set in the multiple search space sets on condition that the at least two bits indicate target information, where the target information contains information indicative of whether parameter change occurs to each search space set in the multiple search space sets.

FIG. 4 illustrates an apparatus 400 for data processing provided in implementations of the disclosure. The apparatus 400 may be a network device or a chip in the network device. The apparatus 400 includes a transmitting unit 410 configured to transmit a PDCCH, where one or more bits in the PDCCH are used to determine whether parameter change occurs to one or more search space sets.

In an implementation manner, parameter non-change of a search space set indicates that a periodicity of the search space set is a periodicity of a configured search space set.

In an implementation manner, parameter change of a search space set indicates that a periodicity of the search space set is N times a periodicity of a configured search space set, where N is an integer large than 1.

In an implementation manner, parameter non-change of a search space set indicates that a periodicity of the search space set is a first periodicity of the configured search space set.

In an implementation manner, parameter change of a search space set indicates that a periodicity of the search space set is a second periodicity of the configured search space set.

In an implementation manner, parameter non-change of a search space set indicates that any parameter of the search space set is unchanged.

In an implementation manner, parameter change of a search space set indicates that a PDCCH MO of the search space set is skipped for a duration.

In an implementation manner, the duration includes Y monitoring periodicities, Y slots, or Y milliseconds, where Y is a positive integer.

In an implementation manner, the one or more bits in the PDCCH being used to determine whether parameter change occurs to the one or more search space sets includes that one bit in the PDCCH is used to determine whether parameter change occurs to one search space set.

Optionally, the one search space set is a search space set to which the PDCCH belongs.

Optionally, parameter non-change is determined to occur to the one search space set on condition that the one bit indicates parameter non-change, or parameter change is determined to occur to the one search space set on condition that the one bit indicates parameter change.

In an implementation manner, the one or more bits in the PDCCH being used to determine whether parameter change occurs to the one or more search space sets includes that two bits in the PDCCH are used to determine whether parameter change occurs to two search space sets.

Optionally, the two search space sets include the search space set to which the PDCCH belongs and a search space set associated with the PDCCH.

Optionally, parameter non-change is determined to occur to a search space set corresponding to one bit in the two bits on condition that the one bit indicates parameter non-change, and parameter change is determined to occur to the search space set corresponding to the one bit in the two bits on condition that the one bit indicates parameter change.

In an implementation manner, the one or more bits in the PDCCH being used to determine whether parameter change occurs to the one or more search space sets includes that at least two bits in the PDCCH are used to determine whether parameter change occurs to multiple search space sets.

Optionally, the multiple search space sets include the search space set to which the PDCCH belongs and at least two search space sets associated with the PDCCH.

Optionally, the at least two bits indicate target information, where the target information contains information indicative of whether parameter change occurs to each search space set in the multiple search space sets.

It is to be understood that the apparatus 300 and the apparatus 400 are embodied in the form of functional units. The term “unit” can refer to an application-specific integrated circuit (ASIC), an electronic circuitry, a processor (such as a shared processor, a dedicated processor, or a multiprocessor) for executing one or more software or firmware programs and a memory, a combinational logic circuit and/or other suitable components that support the functionality described herein. In an optional example, those skilled in the art will appreciate that apparatus 300 may be the UE in the implementations described above, and the apparatus 400 may be the network device in the implementations described above. The apparatus 300 can be used to execute various processes and/or operations executed by the UE in the method implementations described above, and the apparatus 400 can be used to execute various processes and/or operations executed by the network device in the method implementations described above, which is not repeated herein to avoid repetition.

The apparatus 300 in each of the above-described solutions can implement corresponding operations executed by the UE in the forgoing method, and the apparatus 400 in each of the above-described solutions can implement corresponding operations executed by the network device in the forgoing method. The functions can be implemented through hardware or hardware executing corresponding software. The hardware or software includes one or more modules corresponding to the functions described above. For example, the transmitting unit can be replaced by a transmitter, the receiving unit can be replaced by a receiver, and other units such as the determining unit can be replaced by a processor, to perform the receiving and transmitting operations and related processing in the various method implementations.

In the implementations of the disclosure, the apparatus 300 in FIG. 3 or the apparatus 400 in FIG. 4 may also be a chip or a chip system, such as a system-on-chip (SoC). Correspondingly, the receiving unit and the transmitting unit may be a transceiving circuit of the chip, and there is no limitation in this regard.

FIG. 5 illustrates a computer device 500 in implementations of the disclosure. The computer device 500 includes a processor 510, a memory 520, a transceiver 530, and one or more programs. The one or more programs are stored in the memory 520 and configured to be executed by the processor 510.

Optionally, the computer device is a UE, and the above programs include instructions for executing the following operations. Receive a PDCCH. Obtain one or more bits in the PDCCH. Determine whether parameter change occurs to one or more search space sets based on the one or more bits.

Optionally, parameter non-change of a search space set indicates that a periodicity of the search space set is a periodicity of a configured search space set.

Optionally, parameter change of a search space set indicates that a periodicity of the search space set is N times a periodicity of the configured search space set, where N is an integer large than 1.

Optionally, parameter non-change of a search space set indicates that a periodicity of the search space set is a first periodicity of the configured search space set.

Optionally, parameter change of a search space set indicates that a periodicity of the search space set is a second periodicity of the configured search space set.

Optionally, parameter non-change of a search space set indicates that any parameter of the search space set is unchanged.

Optionally, parameter change of a search space set indicates that a PDCCH MO of the search space set is skipped for a duration.

Optionally, the duration includes Y monitoring periodicities, Y slots, or Y milliseconds, where Y is a positive integer.

Optionally, the above programs further include instructions for performing the following operations. Start a timer upon determining that parameter change occurs to a search space set. Determine that parameter non-change occurs to the search space set in response to expiration of the timer.

Optionally, the above programs further include instructions for performing the following operations. Determine that parameter non-change occurs to a search space set in a next DRX cycle.

Optionally, in terms of determining whether parameter change occurs to the one or more search space sets based on the one or more bits, the above programs include instructions for performing the following operations. Determine whether parameter change occurs to one search space set based on one bit.

The search space set is a search space set to which the PDCCH belongs.

Parameter non-change is determined to occur to the one search space set on condition that the one bit indicates parameter non-change, and parameter change is determined to occur to the one search space set on condition that the one bit indicates parameter change.

Optionally, in terms of determining whether parameter change occurs to the one or more search space sets based on the one or more bits, the above programs include instructions for performing the following operations. Determine whether parameter change occurs to two search space sets based on two bits.

The two search space sets include the search space set to which the PDCCH belongs and a search space set associated with the PDCCH.

Parameter non-change is determined to occur to a search space set corresponding to one bit in the two bits on condition that the one bit indicates parameter non-change, and parameter change is determined to occur to the search space set corresponding to the one bit in the two bits on condition that the one bit indicates parameter change.

Optionally, in terms of determining whether parameter change occurs to the one or more search space sets based on the one or more bits, the above programs include instructions for determining the following operations. Determine whether parameter change occurs to multiple search space sets based on at least two bits.

The multiple search space sets include the search space set to which the PDCCH belongs and at least two search space sets associated with the PDCCH.

The above programs further include instructions for performing the following operations. Determine whether parameter change occurs to each search space set in the multiple search space sets on condition that the at least two bits indicate target information, where the target information contains information indicative of whether parameter change occurs to each search space set in the multiple search space sets.

In another possible implementation manner, the computer device is a network device. The above programs include instructions for performing the following operations. Transmit a PDCCH, where one or more bits in the PDCCH are used to determine whether parameter change occurs to one or more search space sets.

Optionally, parameter non-change of a search space set indicates that a periodicity of the search space set is a periodicity of a configured search space set.

Optionally, parameter change of a search space set indicates that a periodicity of the search space set is N times a periodicity of the configured search space set, where N is an integer large than 1.

Optionally, parameter non-change of a search space set indicates that a periodicity of the search space set is a first periodicity of the configured search space set.

Optionally, parameter change of a search space set indicates that a periodicity of the search space set is a second periodicity of the configured search space set.

Optionally, parameter non-change of a search space set indicates that any parameter of the search space set is unchanged.

Optionally, parameter change of a search space set indicates that a PDCCH MO of the search space set is skipped for a duration.

Optionally, the duration includes Y monitoring periodicities, Y slots, or Y milliseconds, where Y is a positive integer.

Optionally, the one or more bits in the PDCCH being used to determine whether parameter change occurs to the one or more search space sets includes that one bit in the PDCCH is used to determine whether parameter change occurs to one search space set.

The one search space set is a search space set to which the PDCCH belongs.

Parameter non-change is determined to occur to the one search space set on condition that the one bit indicates parameter non-change, and parameter change is determined to occur to the one search space set on condition that the one bit indicates parameter change.

Optionally, the one or more bits in the PDCCH being used to determine whether parameter change occurs to the one or more search space sets includes that two bits in the PDCCH are used to determine whether parameter change occurs to two search space sets.

The two search space sets include the search space set to which the PDCCH belongs and a search space set associated with the PDCCH.

Parameter non-change is determined to occur to a search space set corresponding to one bit in the two bits on condition that the one bit indicates parameter non-change, and parameter change is determined to occur to the search space set corresponding to the one bit in the two bits on condition that the one bit indicates parameter change.

Optionally, the one or more bits in the PDCCH being used to determine whether parameter change occurs to the one or more search space sets includes that at least two bits in the PDCCH are used to determine whether parameter change occurs to multiple search space sets.

The multiple search space sets include the search space set to which the PDCCH belongs and at least two search space sets associated with the PDCCH.

The at least two bits indicate target information, where the target information contains information indicative of whether parameter change occurs to each search space set in the multiple search space sets.

It is to be understood that the memory 520 may include both a read-only memory (ROM) and a random-access memory (RAM), and provides instructions and data to the processor. The memory may further include a non-volatile random-access memory (NVRAM). For example, the memory may also store information about device type.

It is to be understood that, in the implementation of the disclosure, the processor 510 of the above-mentioned apparatus may be a central processing unit (CPU). The processor 510 may also be other general-purpose processors such as a digital signal processor (DSP), an application-specific integrated circuit (ASIC), a field-programmable gate array (FPGA) or other programmable logic devices, a discrete gate or a transistor logic device, or a discrete hardware component. The general-purpose processor may be a microprocessor or any conventional processor, etc.

In the implementation process, various operations of the above-mentioned methods can be completed through a hardware integrated logic circuit in the processor or in the form of software instructions. The operations of the method disclosed in the implementations of the disclosure can be directly embodied as executed by a hardware processor, or executed by a combination of hardware and software units in the processor. The software unit can be located in a mature storage medium in the field such as a RAM, a flash memory, a ROM, a programmable ROM (PROM) or an electrically erasable programmable memory (EEPROM), or a register. The storage medium is located in the memory, and the processor executes instructions in the memory to perform the operations in the above-mentioned methods in conjunction with the hardware of the processor. To avoid repetition, a detailed illustration is omitted here.

The implementations of the disclosure further provide a computer-readable storage medium. The computer-readable storage medium stores computer programs for electronic data exchange. The computer programs cause a computer to execute some or all of the operations executed by the UE or the network device in the above method implementations.

The implementations of the disclosure also provide a computer program product. The computer program product includes a non-transitory computer-readable storage medium storing computer programs. The computer programs can cause a computer to execute some or all of the operations executed by the UE or the network device in the above method implementations. The computer program product may be a software installation package.

It is to be understood that the term “and/or” in the disclosure is simply an illustration of an association relationship of associated objects, indicating that three relationships may exist, for example, A and/or B, which may indicate the existence of A alone, A and B together, and B alone. In addition, the character “/” in the disclosure generally indicates that associated objects are in an “or” relationship.

Those of ordinary skill in the art will appreciate that units and operations of various methods described in connection with implementations herein can be implemented by electronic hardware, computer software, or a combination of computer software and electronic hardware. To clarify the interchangeability of hardware and software, the above illustrations have generically described operations and components of each implementation according to functions. Whether these functions are performed by means of hardware or software depends on the particular application and the design constraints of the technical solution. Those skilled in the art may use different methods with regard to each particular application to implement the described functions, but such implementation should not be regarded as lying beyond the scope of the disclosure.

It will be evident to those skilled in the art that, for the sake of convenience and simplicity, in terms of the working processes of the foregoing systems, apparatuses, and units, reference can be made to the corresponding processes of the above method implementations, which will not be repeated herein.

It will be appreciated that the systems, apparatuses, and methods disclosed in implementations herein may also be implemented in various other manners. For example, the above apparatus implementations are merely illustrative, e.g., the division of units is only a division of logical functions, and there may be other manners of division in practice, e.g., multiple units or components may be combined or may be integrated into another system, or some features may be ignored or skipped. In other respects, the coupling or direct coupling or communication connection as illustrated or discussed may be an indirect coupling or communication connection through some interfaces, devices, or units, and may be electrical, mechanical, or otherwise.

Separated units as illustrated may or may not be physically separated. Components or parts displayed as units may or may not be physical units, and may reside at one location or may be distributed to multiple networked units. Some or all of the units may be selectively adopted according to practical needs to achieve desired objectives of the implementations of the disclosure.

In addition, various functional units described in implementations herein may be integrated into one processing unit or may be present as a number of physically separated units, and two or more units may be integrated into one unit. The integrated unit may be in the form of hardware or a software functional unit.

If the integrated units are implemented as software functional units and sold or used as standalone products, they may be stored in a computer-readable storage medium. Based on such an understanding, the essential technical solution, or the portion that contributes to the related art, or all or part of the technical solution of the disclosure may be embodied as software products. The computer software products may be stored in a storage medium and may include multiple instructions that, when executed, can cause a computer device, e.g., a personal computer, a server, a network device, etc., to execute some or all operations of the methods described in various implementations. The above storage medium may include various kinds of media that can store program codes, such as a universal serial bus (USB) flash disk, a mobile hard drive, a ROM, a RAM, a magnetic disk, or an optical disk.

The above illustration is only a specific implementation of the disclosure, and the protection scope of the disclosure is not limited thereto. Any person skilled in the art can easily conceive various equivalent modifications or substitutions within the technical scope disclosed in the disclosure, and these modifications or substitutions should also fall in the protection scope of the disclosure. Therefore, the protection scope of the disclosure shall be subject to the scope of the claims.

1. A method for data processing, comprising:
receiving a physical downlink control channel (PDCCH) and obtaining one or more bits in the PDCCH; and
determining whether parameter change occurs to one or more search space sets based on the one or more bits.

2. The method of claim 1, wherein parameter non-change of a search space set indicates that a periodicity of the search space set is a periodicity of a configured search space set.

3. The method of claim 1, wherein parameter change of a search space set indicates that a periodicity of the search space set is N times a periodicity of a configured search space set, wherein N is an integer large than 1.

4-5. (canceled)

6. The method of claim 1, wherein parameter non-change of a search space set indicates that any parameter of the search space set is unchanged.

7. The method of claim 1, wherein parameter change of a search space set indicates that a PDCCH monitoring occasion (MO) of the search space set is skipped for a duration.

8. The method of claim 7, wherein the duration comprises Y monitoring periodicities, Y slots, or Y milliseconds, wherein Y is a positive integer.

9. The method of claim 1, further comprising:
starting a timer upon determining that parameter change occurs to a search space set; and
determining that parameter non-change occurs to the search space set in response to expiration of the timer.

10. The method of claim 1, further comprising:
determining that parameter non-change occurs to a search space set in a next discontinuous reception (DRX) cycle.

11. The method of claim 1, wherein determining whether parameter change occurs to the one or more search space sets based on the one or more bits, comprises:
determining whether parameter change occurs to one search space set based on one bit.

12. The method of claim 11, wherein the one search space set is a search space set to which the PDCCH belongs.

13. The method of claim 11, wherein parameter non-change is determined to occur to the one search space set on condition that the one bit indicates parameter non-change; and
parameter change is determined to occur to the one search space set on condition that the one bit indicates parameter change.

14. The method of claim 1, wherein determining whether parameter change occurs to the one or more search space sets based on the one or more bits, comprises:
determining whether parameter change occurs to two search space sets based on two bits.

15. The method of claim 14, wherein the two search space sets comprise a search space set to which the PDCCH belongs and a search space set associated with the PDCCH.

16. The method of claim 14, wherein parameter non-change is determined to occur to a search space set corresponding to one bit in the two bits on condition that the one bit indicates parameter non-change; and
parameter change is determined to occur to the search space set corresponding to the one bit in the two bits on condition that the one bit indicates parameter change.

17. The method of claim 1, wherein determining whether parameter change occurs to the one or more search space sets based on the one or more bits, comprises:
determining whether parameter change occurs to a plurality of search space sets based on at least two bits.

18. The method of claim 17, wherein the plurality of search space sets comprise a search space set to which the PDCCH belongs and at least two search space sets associated with the PDCCH.

19. The method of claim 17, further comprising:
determining whether parameter change occurs to each search space set in the plurality of search space sets on condition that the at least two bits indicate target information, wherein the target information contains information indicative of whether parameter change occurs to each search space set in the plurality of search space sets.

20. A method for data processing, comprising:
transmitting a physical downlink control channel (PDCCH), wherein one or more bits in the PDCCH are used to determine whether parameter change occurs to one or more search space sets.

21-36. (canceled)

37. A user equipment (UE), comprising:
a transceiver;
a processor coupled with the transceiver; and
a memory storing a computer program which, when executed by the processor, causes the UE to:
receive a physical downlink control channel (PDCCH);
obtain one or more bits in the PDCCH; and
determine whether parameter change occurs to one or more search space sets based on the one or more bits.

38-44. (canceled)

45. The UE of claim 37, wherein
parameter non-change of a search space set indicates that a periodicity of the search space set is a periodicity of a configured search space set; or
parameter change of a search space set indicates that a periodicity of the search space set is N times a periodicity of a configured search space set, wherein N is an integer large than 1.
